(19) United States
(12) Patent Application Publication
(10) Pub. No.: US 2025/0268140 A1
(43) Pub. Date: Aug. 28, 2025

(54) INDIVIDUAL FRUIT HARVEST ASSISTER

(71) Applicant: Move & Pick Ltd., Sarona (IL)

(72) Inventors: Doron BITAN, Kfar Blum (IL); Avi HADAR, Kfar Tavor (IL)

(73) Assignee: Move & Pick Ltd., Sarona (IL)

(21) Appl. No.: 18/855,443

(22) PCT Filed: Apr. 10, 2023
(86) PCT No.: PCT/IL2023/050387

§ 371 Date: Oct. 9, 2024

Related U.S. Application Data
(60) Provisional application No. 63/330,043, filed on Apr. 12, 2022.

(51) Int. Cl. A01D 46/253; B65G 17/12; B65G 41/00; B65G 47/38; B66F 9/065

(52) U.S. Cl. CPC A01D 46/253; B65G 17/12; B65G 41/003; B65G 41/007; B65G 47/38; B66F 9/065; B65G 2201/0211; B65G 2203/047; B65G 2207/42

(57) ABSTRACT

A harvesting assisting machine which may include: a frame having a longitudinal frame axis, the frame including: a first and second side frame portions extending in a vertical direction and disposed on opposing sides of the longitudinal frame axis, a third frame portion interconnecting the first and second side frame portion, wherein the first and second side frame portions and the third frame portion create a container space configured to accommodate a container: a plurality of wheels coupled to bottom portions of the first and second side frame portions; and a container holding and lifting assembly coupled to the frame, the container holding and lifting assembly being configured to releasably hold the container within the container space and to elevate and lower the container in the vertical direction.

### FIELD OF THE INVENTION

The present invention relates to the field of harvesting assisting machines, and more particularly, to fruits and/or vegetables harvesting assisting machines.

### BACKGROUND OF THE INVENTION

Current harvesting assisting machines and particularly fruits and/or vegetables harvesting assisting machines typically include container platforms for carrying containers, and conveyors that receive and deliver picked items such as fruits and/or vegetables into the container. Current harvesting assisting machines typically cannot automatically pick up containers from the ground and require dedicated tools, such as forklifts, for positioning and removing containers from the container platforms. This may slow down the harvesting process and require the presence of tools like forklifts in the field.

Current harvesting assisting machines typically cannot pass above containers deployed in the field. Current harvesting assisting machines typically need to maneuver to bypass the containers in the field, which is not always possible due to, for example, limited space between for example tree lines in the field. Current methods include having tools like forklifts in the field to move the containers.

Current harvesting assisting machines are typically used by a group of users simultaneously, which may limit the average harvesting rate of the group to the harvesting rate of the user having the slower harvesting rate, for example as expressed by an equation below:

$$( Average harvesting rate of the group ) == ( Number of users ) \times ( Harvesting rate of the slower user ) / ( Number of users ) == ( Harvesting rate of slower user )$$

### SUMMARY OF THE INVENTION

Embodiments of the present invention may provide a harvesting assisting machine which may include: a frame having a longitudinal frame axis, the frame may include: a first side frame portion and a second side frame portion extending in a vertical direction that is perpendicular to the longitudinal frame axis, the first side frame portion and second side frame portion being disposed on opposing sides of the longitudinal frame axis, a third frame portion interconnecting the first side frame portion and the second side frame portion, wherein the first side frame portion, the second side frame portion and the third frame portion create a container space extending along the entire length of the longitudinal frame axis, the container space being configured to accommodate a container; a plurality of wheels coupled to bottom portions of the first side frame portion and second side frame portion; and a container holding and lifting assembly coupled to the frame, the container holding and lifting assembly being configured to releasably hold the container within the container space and to elevate and lower the container in the vertical direction.

In some embodiments, the container holding and lifting assembly includes a plurality of structural elements retractably extendable into the container space, the structural elements being configured to engage with the container when extended into the container space.

In some embodiments, the container holding and lifting assembly includes a plurality of prongs coupled to bottom portions of the first side frame portion and second side frame portion, the prongs being retractably extendable into the container space and being configured to engage with a bottom surface of the container.

In some embodiments, the prongs are rotatable about respective rotation axes to extend into the container space and retract from the container space, the rotation axes being parallel to the vertical direction.

In some embodiments, the prongs are slidable into the container space and from the container space to extend into the container space and retract from the container space, respectively.

In some embodiments, the container holding and lifting assembly includes a plurality container holders coupled to bottom portions of the first side frame portion and the second side frame portion, the container holders being retractably extendable into the container space and being configured to engage with side surfaces of the container.

In some embodiments, the container holding and lifting assembly includes: two pairs of sub-assemblies, each of the pairs being coupled to a bottom portion of one of the first side frame portion and the second side frame portion and may include: a lifting sub-assembly coupled to the bottom portion of the respective side frame portion; and a prongs actuating sub-assembly coupled to the lifting sub-assembly.

In some embodiments, the prongs actuating sub-assembly includes: a prongs supporting structure extending in a direction that is parallel to the longitudinal frame axis; and a first prong and a second prong of the plurality of prongs coupled to the prongs supporting structure at opposing ends of the prongs supporting structure, the first prong and the second prong being rotatable with respect to the prongs supporting structure about rotation axes extending in the vertical direction; an actuator coupled to the prongs supporting structure; and a rod coupled to the actuator, the first prong and the second prong, the rod extending in the direction that is parallel to the longitudinal frame axis; wherein the actuator and the rod are configured to cause the first prong and the second prong to rotate with respect to the prongs supporting structure.

In some embodiments, the direction of rotation of the first prong and the second prong with respect to the prongs supporting structure upon actuation is dictated by positions of coupling points of the rod to the first prong and the second prong relative to an axis extending through the first prong and the second prong and being parallel to the longitudinal frame axis.

In some embodiments, the lifting sub-assembly includes: a sub-frame coupled to the to the bottom portion of the respective side frame portion, the sub-frame extending in a direction that is parallel to the longitudinal frame axis; a first crankshaft and a second crankshaft coupled to the sub-frame along an axis that is parallel to the longitudinal frame axis, the first crankshaft and the second crankshaft being rotatable with respect to the sub-frame about respective rotation axes that are perpendicular to the longitudinal frame axis, the first crankshaft and the second crankshaft being coupled to the prongs actuating sub-assembly; a motor coupled to the sub-frame; and a transmission coupling the motor to the first crankshaft and the second crankshaft; wherein the motor and the transmission are configured to cause the first crankshaft and the second crankshaft to rotate to elevate and lower the prongs actuating sub-assembly coupled thereto.

In some embodiments, the machine include an items arranging assembly coupled to the frame, the items arranging assembly being configured to receive items and arrange the items in the container.

In some embodiments, the items arranging assembly includes a vertical conveyor sub-assembly, the vertical conveyor sub-assembly may include: a conveyor belt holder extending in the vertical direction and supporting a conveyor belt; an arm coupled to a bottom portion of the conveyor belt holder and may include a concave surface configured to receive the items from the conveyor belt and deliver the items into the container, the arm being rotatable about a rotation axis that extends in the vertical direction; and a lifting mechanism configured to lower the conveyor belt holder into the container space and elevate the conveyor belt holder from within the container space in the vertical direction.

In some embodiments, the conveyor belt includes a plurality of item retaining members configured to retain items.

In some embodiments, the items arranging assembly includes a sensor configured to determine that a distance between the arm and the items in the container is below a threshold.

In some embodiments, the machine includes a controller configured to control the lifting mechanism to elevate the conveyor belt holder in the vertical direction if it is determined that the distance is below the threshold.

In some embodiments, the sensor includes a brush coupled to the arm and a microswitch configured to sense a contact of the brush with the items in the container.

In some embodiments, the items arranging assembly includes a transverse conveyor sub-assembly, the transverse conveyor sub-assembly comprising a conveyor belt holder and supporting a conveyor belt, the conveyor belt holder extending substantially in a direction that is transverse to the vertical direction.

In some embodiments, the conveyor belt of the transverse conveyor sub-assembly includes a plurality of item retaining members configured to retain items.

In some embodiments, the third frame portion is a retractable and extendable in a direction that is perpendicular to the longitudinal frame axis and the vertical direction to change a distance between the first side frame portion and the second side frame portion.

In some embodiments, the machine includes a platform on which a user may stand, the platform being coupled to the frame.

In some embodiments, the platform is retractable and extendable in the vertical direction, in a direction that is transverse to the vertical direction, or in both directions.

In some embodiments, the machine includes a plurality of motors, each of the motors being configured to power one of the wheels.

In some embodiments, the machine includes a battery coupled to the frame, the battery being configured to supply power to components of the machine.

In some embodiments, the machine includes a controller configured to control operation of components of the machine.

### BRIEF DESCRIPTION OF THE DRAWINGS

For a better understanding of embodiments of the invention and to show how the same can be carried into effect, reference is made, purely by way of example, to the accompanying drawings in which like numerals designate corresponding elements or sections throughout. In the accompanying drawings:

FIGS. 1A and 1B are schematic illustrations of a harvesting assisting machine, according to some embodiments of the invention;

FIG. 1C is a schematic illustration of the machine of FIGS. 1A-1B holding a container, according to some embodiments of the invention;

FIG. 2 is a schematic illustration of a frame of the machine of FIGS. 1A-1B, according to some embodiments of the invention;

FIGS. 3A and 3B are schematic illustrations of the frame, wheels and motors of the machine of FIGS. 1A-1B, according to some embodiments of the invention;

FIG. 4A is a schematic illustration of the frame and a container holding and lifting assembly of the machine of FIGS. 1A-1B, wherein container holding and lifting assembly includes a plurality of prongs, according to some embodiments of the invention;

FIG. 4B is a schematic illustration of the frame and the container holding and lifting assembly of the machine of FIGS. 1A-1B holding the container, according to some embodiments of the invention;

FIGS. 5A, 5B and 5C are schematic illustrations of a prongs actuating sub-assembly and a lifting sub-assembly of the container holding and lifting assembly of the machine of FIGS. 1A-1B, wherein the prongs actuating sub-assembly is configured to rotate the prongs, according to some embodiments of the invention;

FIG. 6 is a schematic illustration of a prong actuating sub-assembly of the container holding and lifting assembly of the machine of FIGS. 1A-1B, wherein the prongs actuating sub-assembly is configured to slide the prongs, according to some embodiments of the invention;

FIGS. 7A and 7B are schematic illustrations of the frame and the container holding and lifting assembly of the machine of FIGS. 1A-1B, wherein the container holding and lifting assembly includes a plurality of container holders, according to some embodiments of the invention;

FIG. 7C is a schematic illustration of the frame and the container holding and lifting assembly of the machine of FIGS. 7A-7B holding container 90, according to some embodiments of the invention;

FIG. 7D is a schematic illustration of a container holder actuating sub-assembly of the container holding and lifting assembly of FIGS. 7A-7C, according to some embodiments of the invention;

FIG. 8A is a schematic illustration of the frame and an items arranging assembly of the machine of FIGS. 1A-1B, according to some embodiments of the invention;

FIG. 8B is a schematic illustration of a vertical conveyor sub-assembly of the items arranging assembly of the machine of FIGS. 1A-1B, according to some embodiments of the invention;

FIG. 9 is a schematic illustration of the frame and a platform of the machine of FIGS. 1A-1B, according to some embodiments of the invention; and

FIGS. 10A-10J are schematic illustrations of the machine of FIGS. 1A-1B in operation, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

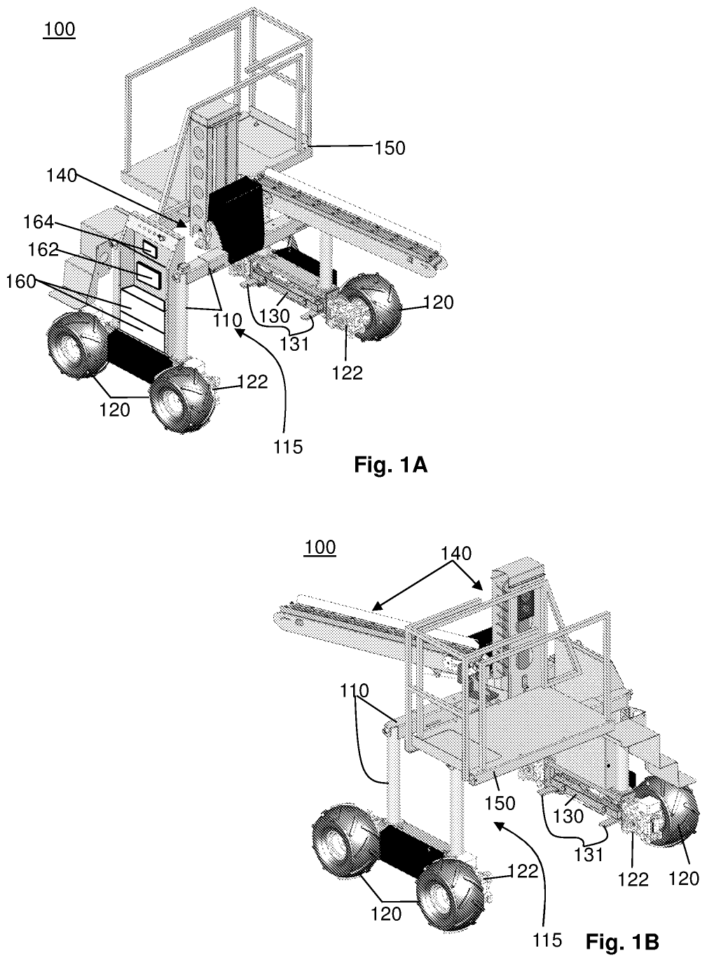

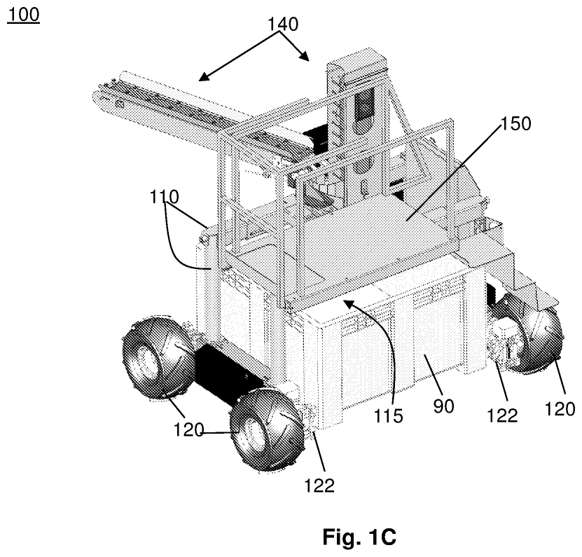

Reference is made to FIGS. 1A and 1B, which are schematic illustrations of a harvesting assisting machine 100, according to some embodiments of the invention. FIGS. 1A and 1B show different perspective views of machine 100.

Reference is also made to FIG. 1C, which is a schematic illustration of machine 100 holding a container 90, according to some embodiments of the invention. FIG. 1C shows a perspective view of machine 100.

Machine 100 may be used for assisting in harvesting of fruits, vegetables or any other suitable crops that need to be picked or otherwise collected from trees, shrubs or any other plant. Machine 100 may be self-propelled (e.g., may move without external propulsion).

Machine 100 may include a frame 110. Frame 110 may have a container space 115 (e.g., as shown in FIGS. 1A-1B) for accommodating a container 90 (e.g., as shown in FIG. 1C).

Machine 100 may include a plurality of wheels 120 coupled to frame 110. Machine 100 may include a plurality of motors 122. Each of motors 122 may, for example, power (e.g., motorize) one of wheels 120.

Machine 100 may include a container holding and lifting assembly 130 coupled to frame 110. Container holding and lifting assembly 130 may include a plurality of structural elements (such as a plurality of prongs 131 as shown in FIGS. 1A-1B) retractably extendable into container space 115. When extended into container space 115, the structural elements (such as prongs 131) may engage with container 90 and hold container 90 within container space 115. Container holding and lifting assembly 130 may elevate and lower container 90 within container space 115.

Machine 100 may include an items arranging assembly 140 coupled to frame 100. Items arranging assembly 140 may receive items such as fruits and/or vegetables and arrange the items within container 90.

Machine 100 may include a platform 150 coupled to frame 110. The user of machine 100 may stand on platform 150 for harvesting fruits and/or vegetables from trees or any other plant.

Machine 100 may include one or more batteries 160 for supplying power to components of machine 100.

Machine 100 may include a controller 162 for controlling components of machine 100. Controller 162 may control components of machine 100 based on, for example, control signals from the user. The user may transmit control signals to controller 162 using, for example, a remote control unit.

Machine 100 may include an interface 164 for connecting electric tools, such as saws or any other suitable tool, to batteries 162 of machine 100.

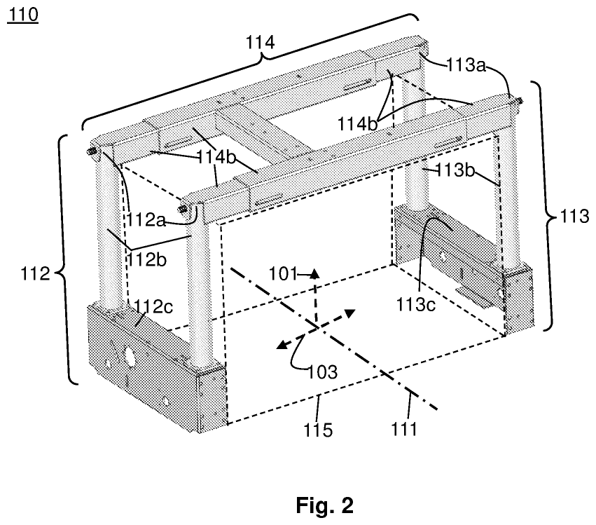

Reference is made to FIG. 2, which is a schematic illustration of frame 110 of machine 100, according to some embodiments of the invention. FIG. 2 shows a perspective view of frame 110.

Frame 110 of machine 100 may have a longitudinal frame axis 111. Longitudinal frame axis 111 may be aligned with a traveling direction of machine 100. Frame 110 may include a first side frame portion 112 and a second side frame portion 113. First side frame portion 112 and second side frame portion 113 may be disposed on opposing sides of longitudinal frame axis 111. First side frame portion 112 and second side frame portion 113 may extend in a vertical direction 101 that is perpendicular (or substantially perpendicular) to longitudinal frame axis 111. Frame 110 may include a third frame portion 114. Third frame portion 114 may interconnect first side frame portion 112 and second side frame portion 113. Third frame portion 114 may be perpendicular (or substantially perpendicular) to first side frame portion 112 and second side frame portion 113. Third frame portion 114 may interconnect, for example, top portions 112a, 113a of first side frame portion 112 and second side frame portion 113, respectively.

Each of first side frame portion 112, second side frame portion 113 and third frame portion 114 may include one or more bars (e.g., bars 112b, 113b, 114b indicated in FIG. 2) or any other suitable structural frame elements. The structural frame elements may be formed of, for example, steel (e.g., ST52 which is carbon manganese steel with good impact resistance or any other suitable steel) or any other suitable material.

First side frame portion 112, second side frame portion 113 and third frame portion 114 may create container space 115 therebetween. Container space 115 may accommodate container 90 (e.g., as described above with respect to FIG. 1C). Container space 115 may be hollow (or substantially hollow). Container space 115 may extend along the entire length of frame 110 along longitudinal frame axis 111. Third frame portion 114 may extend and retract in a transverse direction 103 that is perpendicular to longitudinal frame axis 111 and perpendicular to vertical direction 101 to change a distance between first side frame portion 112 and second side frame portion 113. For example, bars 114b of third frame portion 114 may be telescopic bars that may be extended and retracted in transverse direction 103. Changing the distance between first side frame portion 112 and second side frame portion 113 may, for example, allow container space 115 to accommodate containers of different dimensions. Changing the distance between first side frame portion 112 and second side frame portion 113 may, for example, allow to at least partly fold frame 110 (e.g., when machine 100 is not in use) and unfolding frame 110 (e.g., when machine 100 is in use).

The height of frame 110 (e.g., measured between bottom portions 112c, 113c of first side frame portion 112 and second side frame portion 113) may be within a range of, for example, 1 to 1.5 meters. The width of frame 110 (e.g., measured between first side frame portion 112 and second side frame portion 113) may be within a range of, for example, 2 to 2.5 meters. The length of frame 110 (e.g., measured long longitudinal frame axis 111) may be within a range of, for example, 1.5 to 2.5 meters. The height of center of mass of machine 110 above ground may be within a range of, for example, 70 to 80 cm when machine 100 is not loaded and/or 60 to 70 cm when machine 100 is loaded. Such relatively low center of mass may be advantageous to ensure machine 100 is stable on uneven or rough surfaces of the agricultural field.

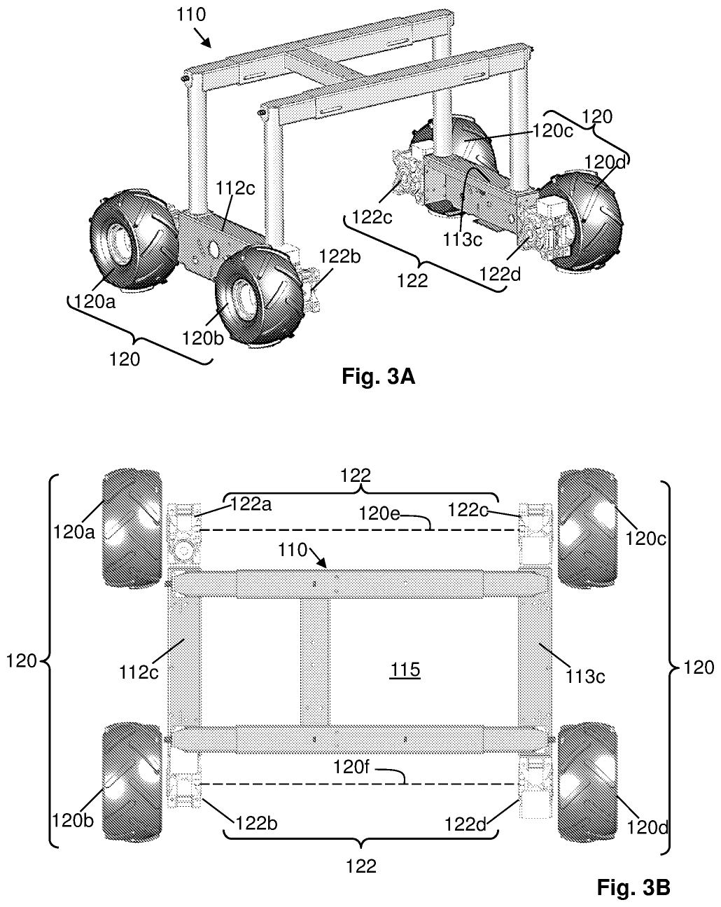

Reference is made to FIGS. 3A and 3B, which are schematic illustrations of frame 110, wheels 120 and motors 122 of machine 100, according to some embodiments of the invention. FIG. 3A shows a perspective view and FIG. 3B shows a top view of frame 110, wheels 120 and motors 122.

Wheels 120 of machine 120 may be coupled to bottom portions 112c, 113c of first side frame portion 112 and second side frame portion 113, respectively.

Machine 100 may, for example, include four wheels 120: a first wheel 120a and a second wheel 120b coupled to bottom portion 112c of first side frame portion 112; and a third wheel 120c and a fourth wheel 120d coupled to bottom portion 113c of second side frame portion 113. First wheel 120a and third wheel 120c may be disposed along a transverse axis 120e that is perpendicular (or substantially perpendicular) to longitudinal frame axis 111 (e.g., as shown in FIG. 3B). Second wheel 120b and fourth wheel 120d may be disposed along a transverse axis 120f that is parallel (or substantially parallel) to transverse axis 120e (e.g., as shown in FIG. 3B).

Machine 100 may include four motors 122, wherein each of motors 122 may be coupled to one of wheels 120 to power (e.g., motorize) the respective wheel. For example, machine 100 may include four motors 122: a first motor 122a coupled to first wheel 120a; a second motor 122b coupled to second wheel 120b; a third motor 122c coupled to third wheel 120c; and a fourth motor 122d coupled to fourth wheel 120d.

Controller 162 may control each of motors 122 to cause machine 100 to move forward or backward, brake and/or steer. For example, forward or backward movement of machine 100 may be achieved by causing all wheels 120 to in the same selected direction at the same (or substantially same) speed. For example, motors 122 may cause wheels 120 to rotate at 17 to 25 rounds per minute. Motors 122 may cause machine 120 to move at the speed of, for example, 4 to 8 kilometers per hour. Steering may be achieved by causing wheels 120a, 120b disposed on first side frame portion 112 to rotate faster or slower (depending on the desired steering direction) than wheels 120c. 120d disposed on second side frame portion 113. Rotation of machine 100 at zero radius may be achieved by rotating wheels 120a. 120b disposed on first side frame portion 112 and wheels 120c, 120d disposed on second side frame portion 113 in opposite directions. Motorizing each of wheels 120 by separate motor 122 may ensure machine 100 is highly maneuverable. High maneuverability of machine 100 may be advantageous to ensure machine 100 can efficiently maneuver in the field between dense tree or other plant lines.

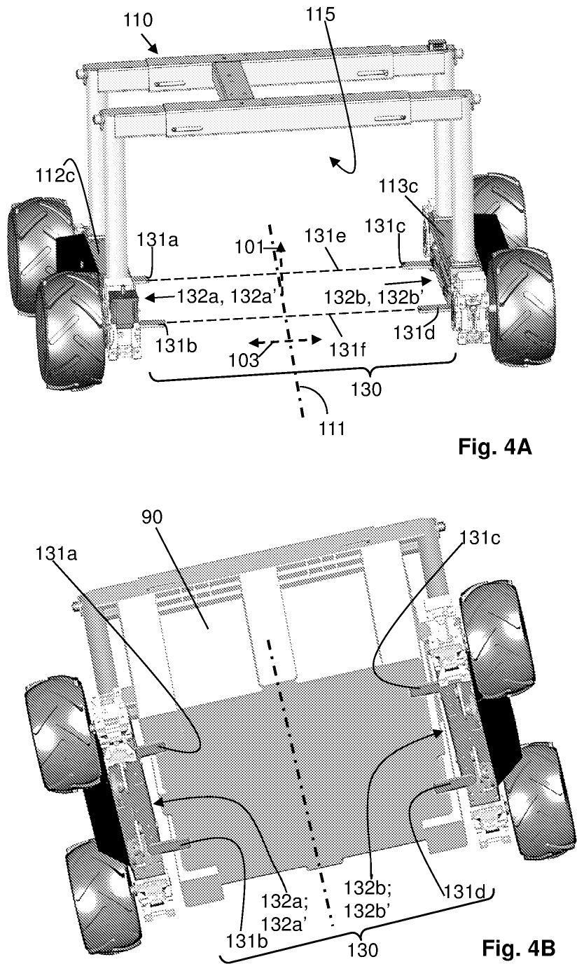

Reference is made to FIG. 4A, which is a schematic illustration of frame 110 and container holding and lifting assembly 130 of machine 100, wherein container holding and lifting assembly 130 includes a plurality of prongs 131, according to some embodiments of the invention. FIG. 4A shows a perspective view of frame 110 and container holding and lifting assembly 130 coupled thereto.

Reference is also made to FIG. 4B, which is a schematic illustration of frame 110 and container holding and lifting assembly 130 of FIG. 4A holding container 90, according to some embodiments of the invention. FIG. 4B shows a perspective view of frame 110, container holding and lifting assembly 130 and container 90.

Container holding and lifting assembly 130 may include a plurality of prongs 131. Prongs 131 may be coupled to bottom portions 112c, 113c of first side frame portion 112 and second side frame portion 113, respectively. For example, container holding and lifting assembly 130 may include four prongs 131: a first prong 131a and a second prong 131b coupled to bottom portion 112c of first side frame portion 112; and a third prong 131c and a fourth prong 131d coupled to bottom portion 113c of second side frame portion 113. First prong 131a and third prong 131c may be disposed on opposing sides of longitudinal frame axis 111 along a transverse axis 131d. Second prong 131b and fourth prong 131d may be disposed on opposing sides of longitudinal frame axis 111 along a transverse axis 131f.

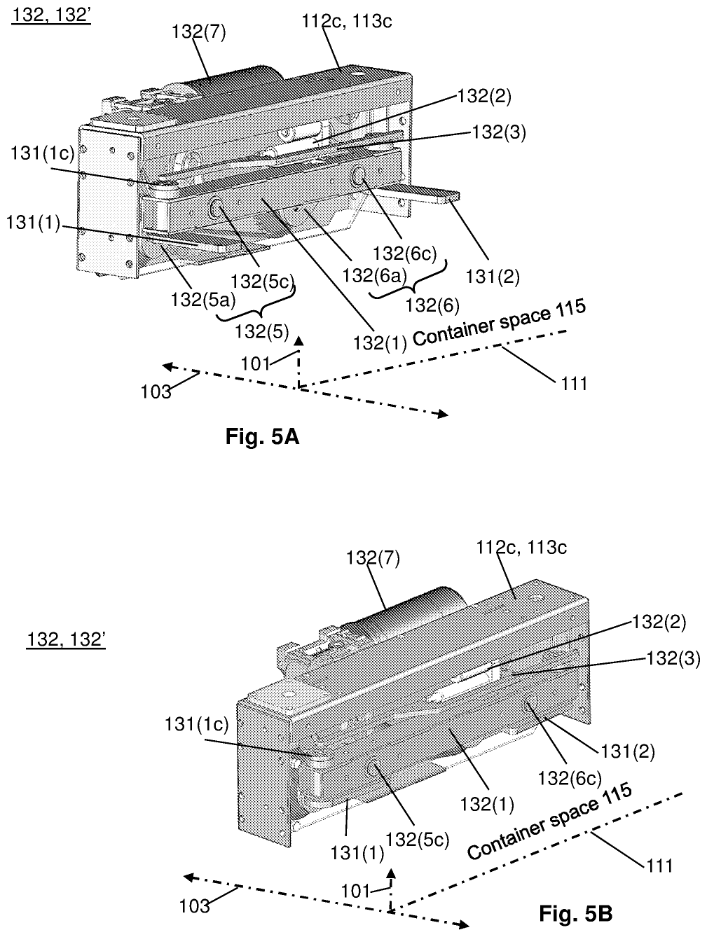

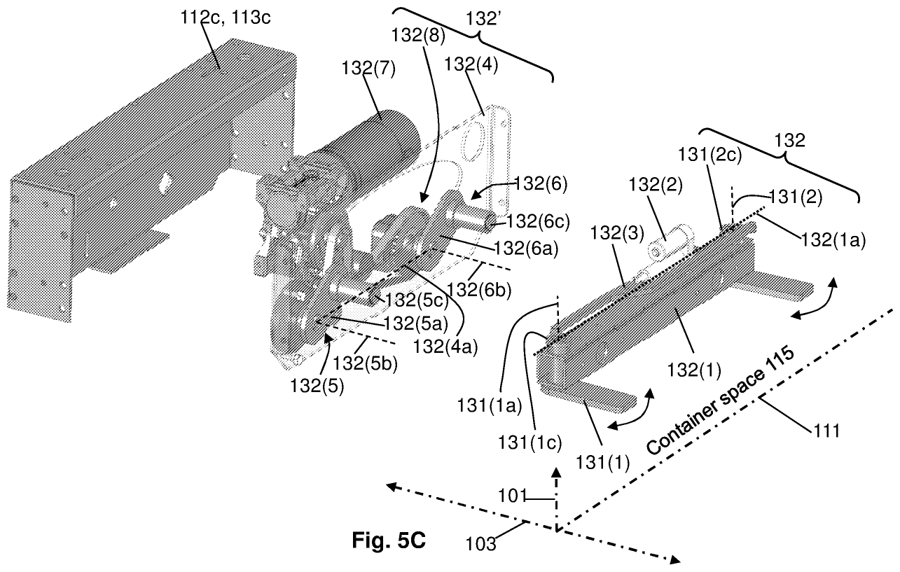

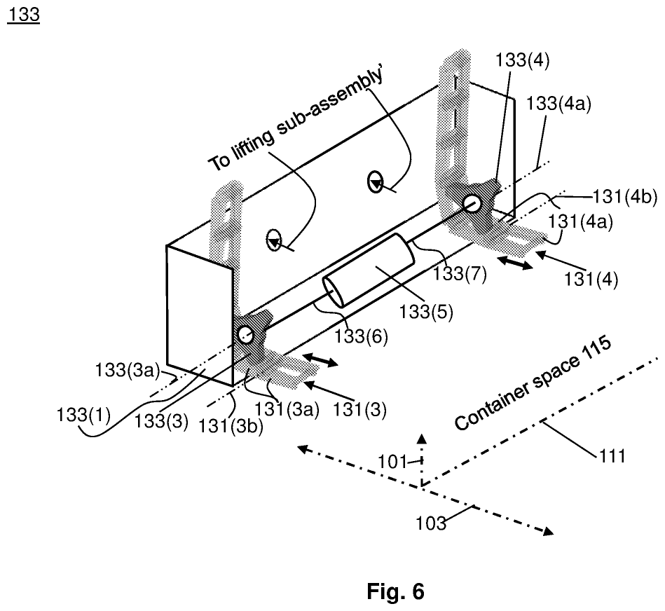

Prongs 131 may be retractably extendable into container space 115 of frame 110. FIGS. 4A and 4B show prongs 131 extending into container space 115. When extended into container space 115, prongs 131 may engage with container 90. For example, prongs 131 may go beneath container 90 when extended into container space 115 (e.g., as shown in FIG. 4B). Prongs 131 may be, for example, rotatable about respective axes that are parallel to vertical direction 101 to extend into container space 115 and retract from container space 115 (e.g., as described below with respect to FIGS. 5A and 5B). In another example, prongs 131 may be slidable in transverse direction 103 into container space 115 and from container space 115 (e.g., as described below with respect to FIG. 6).

Container holding and lifting assembly 130 may include a first prongs actuating sub-assembly 132a and a first lifting sub-assembly 132a′ coupled to bottom portion 112c of first side frame portion 112. First prongs actuating sub-assembly 132a may cause prongs 131a, 131b to extend into container space 115 and to retract from container space 115. First lifting sub-assembly 132a′ may elevate and lower prongs 131a, 131b within container space 115.

Container holding and lifting assembly 130 may include a second prongs actuating sub-assembly 132b and a second lifting sub-assembly 132b′ coupled to bottom portion 113c of second side frame portion 113. Second prongs actuating sub-assembly 132b may cause prongs 131c, 131d to extend into container space 115 and to retract from container space 115. Second lifting sub-assembly 132b′ may elevate and lower prongs 131c. 131d within container space 115.

Reference is made to FIGS. 5A, 5B and 5C, which are schematic illustrations of a prongs actuating sub-assembly 132 and a lifting sub-assembly 132′ of container holding and lifting assembly 130 of machine 100, wherein prongs actuating sub-assembly 132 is configured to rotate prongs 131, according to some embodiments of the invention.

FIGS. 5A and 5B show a perspective view of prongs actuating sub-assembly 132 and lifting sub-assembly 132′. FIG. 5C shows an exploded perspective view of prongs actuating sub-assembly 132 and lifting sub-assembly 132′.

Prongs actuating sub-assembly 132, such as first and second prongs actuating sub-assemblies 132a, 132b described above with respect to FIGS. 4A-4B, may include a prongs supporting structure 132(1). Prongs supporting structure 132(1) may extend in a direction that is parallel (or substantially parallel) to longitudinal frame axis 111. Prongs 131(1) and 131(2) (such as (i) prongs 131a, 131b and/or (ii) prongs 131c, 131d described above with respect to FIGS. 4A-4B) may be coupled to prongs supporting structure 132(1), for example at opposing ends of prongs supporting structure 132(1). Each of prongs 131(1), 131(2) may rotate with respect to prongs supporting structure 132(1) about its respective rotation axis 131(1a), 131(2a) that is parallel (or substantially parallel) to vertical direction 101. Prongs actuating sub-assembly 132 may include an actuator 132(2). Actuator 132(2), such as piston actuator or any other suitable actuator, may be coupled to prongs supporting structure 132(1). Actuator 132(2) may be coupled to prongs 131(1), 131(2) by a rod 132(3). Rod 132(3) may extend in a direction that is parallel (or substantially parallel) to longitudinal frame axis 111. Controller 162 may control actuator 132(2) to cause prongs 131(1), 131(2) to rotate about their respective axes 131(1a), 131(2a) between extended position (e.g., as shown in FIG. 4A) and retracted position (e.g., as shown in FIG. 4B). Prongs 131(1), 131(2) may have, for example, rectangular (or substantially rectangular) shape. Prongs 131(1), 131(2) may have the length within the range of, for example, 140 to 120 millimeters.

Rod 132(3) may be coupled to prongs 131(1), 131(2) using couplers 131(1c), 131(2c) (e.g., as indicated in FIGS. 5A-5C). The way couplers 131(1c), 131(2c) are coupled to prongs 131(1), 131(2) and/or rod 132(3) may dictate the direction of rotation of prongs 131(1), 131(2) when rod 132(3) is actuated by actuator 132(2). In the example of FIGS. 5A-5C, the position of coupling points of couplers 131(1c), 131(2c) to rod 132(3) with respect to an axis 132 (1a) (wherein axis 131(1a) is parallel to longitudinal frame axis 111 and extending through prongs 131(1), 132(2) and/or through couplers 131(1c), 131(2c)) may cause prongs 131(1), 131(2) to rotate inwardly with respect to prongs supporting structure 132(1) when rod 132(3) is actuated by actuator 132(2). Positioning of the coupling point of each of couplers 131(1c), 131(2c) to rod 132(3) at opposing side of axis 132 (1a) as compared to the way couplers 131(1c), 131(2c) are coupled in FIGS. 5A-5C may cause prongs 131(1), 131(2) to rotate outwardly with respect to prongs supporting structure 132(1) when rod 132(3) is actuated by actuator 132(2). Ability to easily change the direction of rotation of prongs 131(1), 131(2) may be important for fitting container holding and lifting assembly 130 to work with different types of containers 90.

Lifting sub-assembly 132′, such as first and second prongs lifting sub-assemblies 132a′. 132b′ described above with respect to FIGS. 4A-4B, may include a sub-frame 132(4). Sub-frame 132(4) of lifting sub-assembly 132′ may be coupled to bottom portions 112c, 113c of first and second side frame portions 112, 113. Sub-frame 132(4) may extend in a direction that is parallel (or substantially parallel) to longitudinal frame axis 111. Lifting sub-assembly 132′ may include a first crankshaft 132(5) and a second crankshaft 132(6). First crankshaft 132(5) may include: a base 132(5a) coupled to sub-frame 132(4) and rotatable with respect to sub-frame 132(4) about a rotation axis 132(5b) that is parallel (or substantially parallel) to transverse direction 103; and a shaft 132(5c) projecting from base 132(5a) in transverse direction 103 and being offset from rotation axis 132(5b). Second crankshaft 132(6) may include: a base 132(6a) coupled to sub-frame 132(4) and rotatable with respect to sub-frame 132(4) about a rotation axis 132(6b) that is parallel (or substantially parallel) to transverse direction 103; and a shaft 132(6c) projecting from base 132(6a) in transverse direction 103 and being offset from rotation axis 132(6b). Rotation axes 132(5b), 132(6b) may be disposed along a longitudinal axis 132(4a) that is parallel (or substantially parallel) to longitudinal frame axis 111. Prongs actuating and lifting sub-assembly 132 may include a motor 132(7) coupled to first crankshaft 132(5) and second crankshaft 132(6) using a transmission 132(8). Transmission 132(8) may, for example, include gears, pulleys, belts and/or any other suitable components.

Prongs actuating sub-assembly 132 may be coupled to lifting sub-assembly 132′. For example, prongs supporting structure 132(1) may be coupled (e.g., rotatably coupled) to first and second crankshafts 132(5), 132(6) (e.g., to shafts 132(5c), 132(6c) of first and second crankshafts 132(5), 132(6), respectively). Lifting sub-assembly 132′ may be coupled to frame 110. For example, sub-frame 132(4) of lifting sub-assembly 132′ may be coupled to bottom portions 112c. 113c of first and second side frame portions 112, 113, respectively. Controller 162 may control motor 132(7) to cause first and second crankshafts 132(5), 132(6) rotate in selected direction to elevate or lower prongs supporting structure 132(1) and prongs 131(1), 131(2) coupled thereto in vertical direction 101.

Prongs actuating sub-assembly 132 and/or lifting sub-assembly 132′ may include sensors (such as proximity sensors, for example magnetic proximity sensors or any other suitable proximity sensors; not shown for simplicity) that may generate signals indicative of whether prongs 131 are in retracted position or extended position and/or whether prongs 131 are in lowered position or elevated position.

Reference is made to FIG. 6, which is a schematic illustration of a prongs actuating sub-assembly 133 of container holding and lifting assembly 130 of machine 100, wherein prongs actuating sub-assembly 133 is configured to slide prongs 131, according to some embodiments of the invention.

Prongs actuating sub-assembly 133, such as first and second prongs actuating sub-assemblies 132a, 132b described above with respect to FIGS. 4A-4B, may include a prongs supporting structure 133(1). Prongs supporting structure 133(1) may extend in a direction that is parallel (or substantially parallel) to longitudinal frame axis 111. Prongs 131(3) and 131(4) (such as (i) prongs 131a, 131b and/or (ii) prongs 131c, 131d described above with respect to FIGS. 4A-4B) may be coupled to prongs supporting structure 133(1), for example at opposing ends of prongs supporting structure 133(1). Each of prongs 131(3), 131(4) may slide from prongs supporting structure 133(1) to extend prongs 131(3), 131(4) from prongs supporting structure 133(1) into container space 115. Each of prongs 131(3), 131(4) may slide from container space 115 into prongs supporting structure 133(1) to retract prongs 131(3), 131(4) from container space 115.

For example, prong 131(3) may include a plurality of interconnected links 131(3a). Links 131(3a) of prong 131(3) may rotate with respect to each other about an axis 131(3b) that is parallel (or substantially parallel) to longitudinal frame axis 111. Links 131(3a) of prong 131(3) may be shaped to rotate with respect to each other only in one direction—e.g., in the upward vertical direction. Links 131(3a) of prong 131(3) may be shaped to prevent links 131(3a) of prong 131(3) in the other downward vertical direction. In the same example, prong 131(4) may include a plurality of interconnected links 131(4a). Links 131(4a) of prong 131(4) may rotate with respect to each other about an axis 131(4b) that is parallel (or substantially parallel) to longitudinal frame axis 111. Links 131(4a) of prong 131(4) may be shaped to rotate with respect to each other only in one direction—e.g., in the upward vertical direction. Links 131(4a) of prong 131(4) may be shaped to prevent links 131(4a) of prong 131(4) in the other downward vertical direction.

Prongs actuating sub-assembly 133 may include a gear 133(2). Gear 133(2) may be disposed within prongs supporting structure 133(1). Gear 133(2) may rotate about an axis 133(2a) that is parallel (or substantially parallel) to longitudinal frame axis 111. When rotated, gear 133(2) may cause at least one link of links 131(3a) of prong 131(3) to slide in transverse direction 103 external to prongs supporting structure 133(1) into container space 115 or slide in transverse direction 103 into prongs supporting structure 133(1) from container space 115 to extend or retract prongs 131(3), respectively.

Prongs actuating sub-assembly 133 may include a gear 133(3). Gear 133(3) may be disposed within prongs supporting structure 133(1). Gear 133(3) may rotate about an axis 133(3a) that is parallel (or substantially parallel) to longitudinal frame axis 111. When rotated, gear 133(3) may cause at least one link of links 131(4a) of prong 131(4) to slide in transverse direction 103 external to prongs supporting structure 133(1) into container space 115 or slide in transverse direction 103 into prongs supporting structure 133(1) from container space 115 to extend or retract prongs 131(4), respectively.

Prongs actuating sub-assembly 133 may include a motor 133(5) and rods 133(6), 133(7) coupling motor 133(5) to gears 133(2), 133(3), respectively. Motor 133(5) may rotate gears 133(2), 133(3) simultaneously. Controller 162 may control motor 133(5) to rotate gears 133(3), 133(4) to extend prongs 131(3), 133(4) into container space 115 or retract prongs 131(3), 133(4) from container space 115. When extracted, links 131(3a), 131(4a) may engage with (e.g., go beneath) container 90.

Prongs actuating sub-assembly 133 may be coupled to a lifting sub-assembly such as lifting sub-assembly 132′ described above with respect to FIGS. 5A-5C or any other suitable lifting sub-assembly. The lifting sub-assembly may be coupled to bottom portions 112c. 113c of first side frame portion 113 and second side frame portion 113 (e.g., as described above with respect to FIGS. 5A-5C).

Prongs actuating sub-assembly 133 may include sensors (such as proximity sensors, for example magnetic proximity sensors or any other suitable proximity sensors; not shown for simplicity) that may generate signals indicative of whether prongs 131 are in retracted position or extended position and/or whether prongs 131 are in lowered position or elevated position.

Advantageously, retractably extendable prongs 131, prongs actuating sub-assemblies 132, 133 and/or lifting sub-assembly 132′ may provide compact solution of releasably holding and lifting of container 90 within container space 115 of frame 110.

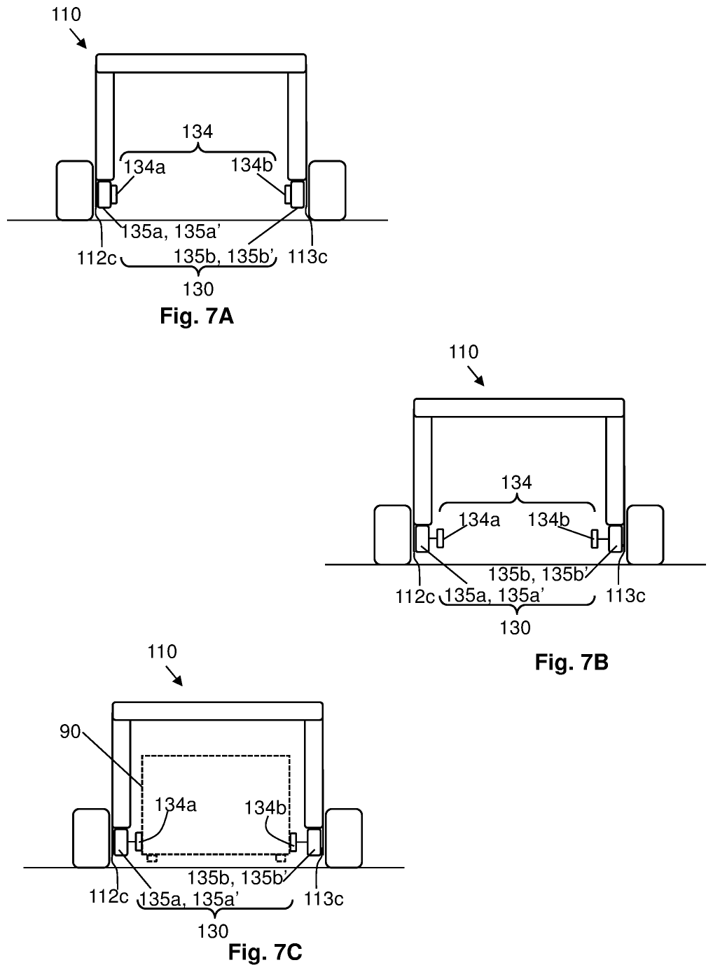

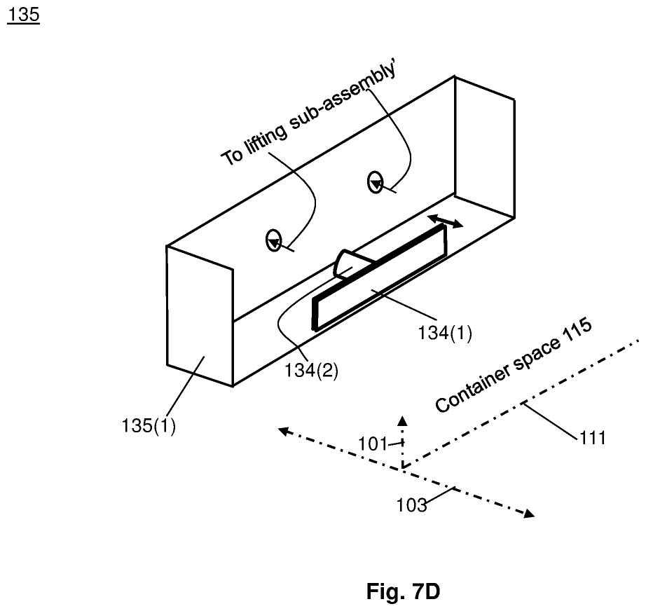

Reference is made to FIGS. 7A and 7B, which are schematic illustrations of frame 110 and container holding and lifting assembly 130 of machine 100, wherein container holding and lifting assembly 130 includes a plurality of container holders 134, according to some embodiments of the invention.

Reference is also made to FIG. 7C, which is a schematic illustration of frame 110 and container holding and lifting assembly 130 of FIGS. 7A-7B holding container 90, according to some embodiments of the invention.

FIGS. 7A and 7B show a schematic rear view of frame 110 and container holding and lifting assembly 130. FIG. 7C shows a schematic rear view of frame 110, container holding and lifting assembly 130 and container 90.

Container holding and lifting assembly 130 may include a plurality of container holders 134. Container holders 134 may be coupled to bottom portions 112c. 113c of first side frame portion 112 and second side frame portion 113, respectively. For example, container holding and lifting assembly 130 may include two container holders 134: a first container holder 134a coupled to bottom portion 112c of first side frame portion 112; and a second container holder 134b coupled to bottom portion 113c of second side frame portion 113. Container holding and lifting assembly 130 may include two or more container holders 134 on each of first side frame portion 112 and second side frame portion 113.

Container holders 134 may be retractably extendable into container space 115. When extended into container space 115, container holders 134 may engage with container 90. For example, when extended first container holder 134a and second container holder 134b may contact opposing sides of container 90 to hold container 90 therebetween.

Container holding and lifting assembly 130 may include a first container holder actuating sub-assembly 135a and a first lifting sub-assembly 135a′ coupled to bottom portion 112c of first side frame portion 112. First container holder sub-assembly 135a may cause container holder 134a to extend into container space 115 and to retract from container space 115. First lifting sub-assembly 135a′ (such as lifting sub-assembly 132′ described above with respect to FIGS. 5A-5C) may elevate and lower container holder 134a within container space 115. Container holding and lifting assembly 130 may include a second container holder actuating sub-assembly 135b and a second lifting sub-assembly 135b′ coupled to bottom portion 113c of second side frame portion 113. Second container holder actuating sub-assembly 135b may cause container holder 134b to extend into container space 115 and to retract from container space 115. Second lifting sub-assembly 135b′ (such as lifting sub-assembly 132′ described above with respect to FIGS. 5A-5C) may elevate and container holder 134b within container space 115.

Reference is made to FIG. 7D, which is a schematic illustration of a container holder actuating sub-assembly 135 of container holding and lifting assembly 130 of FIGS. 7A-7C. according to some embodiments of the invention.

Container holder actuating sub-assembly 135, such as first and second container holder actuating sub-assemblies 135a, 135b described above with respect to FIGS. 7A-7C, may include a container holder supporting structure 135(1). Container holder supporting structure 135(1) may extend in a direction that is parallel (or substantially parallel) to longitudinal frame axis 111.

Container holder actuating sub-assembly 135 may include an actuator 135(2) (e.g., such as piston or any other suitable actuator) coupled to container holder supporting structure 135(1) and container holder 134(1) (such as container holders 134a, 134b described above with respect to FIGS. 7A-7C). Controller 162 may control actuator 135(2) to extend container holder 134(1) into container space 115 and retract container holder 134(1) from container space 115. When extracted, container holder 134(1) may engage with container 90, for example contact the side of container 90 (e.g., as described above with respect to FIG. 7C).

Container holder actuating sub-assembly 135 may be coupled to lifting sub-assembly such as lifting sub-assembly 132′ described above with respect to FIGS. 5A-5C or any other suitable lifting assembly. The lifting sub-assembly may be coupled to bottom portions 112c. 113c of first side frame portion 113 and second side frame portion 113 (e.g., as described above with respect to FIGS. 5A-5C).

Container holder actuating sub-assembly 135 may include sensors (such as proximity sensors, for example magnetic proximity sensors or any other suitable proximity sensors; not shown for simplicity) that may generate signals indicative of whether container holders 134 are in retracted position or extended position and/or whether container holders 134 are in lowered position or elevated position.

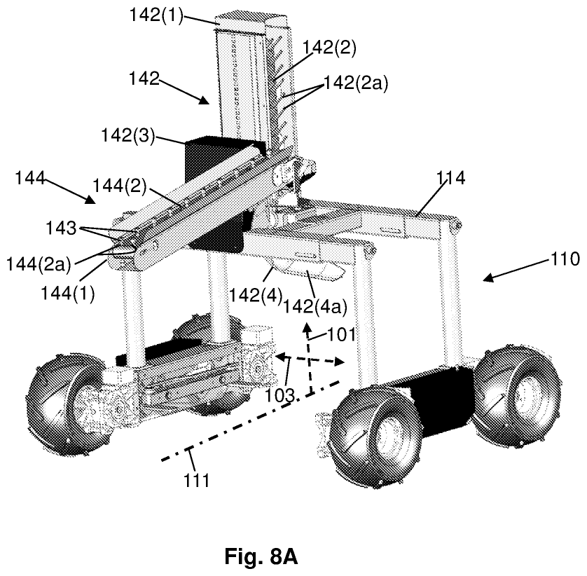

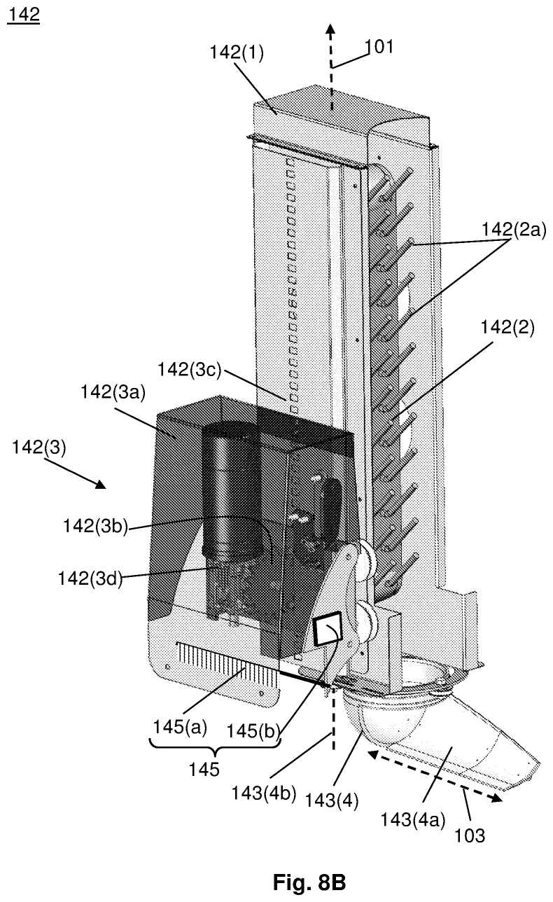

Reference is made to FIG. 8A, which is a schematic illustration of frame 110 and items arranging assembly 140 of machine 100, according to some embodiments of the invention. FIG. 8A shows a perspective view of frame 110 and items arranging assembly 140.

Reference is also made to FIG. 8B, which is a schematic illustration of a vertical conveyor sub-assembly 142 of items arranging assembly 140 of machine 100, according to some embodiments of the invention. FIG. 8B shows a perspective view of vertical conveyor sub-assembly 142.

Items arranging assembly 140 may be coupled to frame 110. For example, components of items arranging assembly 140 may be coupled to third frame portion 114. Items arranging assembly 140 may include a first or vertical conveyor sub-assembly 142. Items arranging assembly 140 may include a second or transverse conveyor sub-assembly 144.

Vertical conveyor sub-assembly 142 may include a conveyor belt holder 142(1) extending in vertical direction 101 and supporting a conveyor belt 142(2). Conveyor belt 142(2) may be formed of, for example, rubber material. Conveyor belt 142(2) may include a plurality of items retaining members 142(2a) projecting from conveyor belt 142(2). Retaining members 142(2a) may retain picked items such as fruits, vegetables and/or any other suitable crop.

Conveyor sub-assembly 142 may include a lifting mechanism 142(3) coupled to frame 110 and to conveyor belt holder 142(1). Lifting mechanism 142(3) may lower and elevate conveyor belt holder 142(1) with respect to frame 110 in vertical direction 101. Lifting mechanism 142(3) may lower conveyor belt holder 142(1) into container space 115. Lifting mechanism 142(3) may elevate conveyor belt holder 142(1) from within container space 115.

For example, lifting mechanism 142(3) may include: a sub-frame 142(3a) coupled to frame 110, a gear 142(3b) rotatably coupled to sub-frame 142(3a), a rack 142(3c) coupled to conveyor belt holder 142(1) and a motor 142(3d) coupled to sub-frame 142(3a) (e.g., as shown in FIG. 8B). Motor 142(3d) may power gear 142(3b). Controller 162 may control motor 142(3d) to lower and elevate conveyor belt holder 142(1) (and conveyor belt 142(2) supported therein) into and from container space 115.

Conveyor sub-assembly 142 may include an arm 142(4) coupled to bottom portion 142 (1a) of conveyor belt holder 142(1). Arm 142(4) may include a concave surface 142(4a) for receiving picked items from conveyor belt 142(2) and delivering the picked items into container 90 when container 90 is disposed within container space 115. Arm 142(4) may extend in a direction that is transverse to vertical direction 101. Arm 142(4) may rotate with respect to conveyor belt holder 142(1) about an axis 142(4b) that is parallel (or substantially parallel) to vertical direction 101. First conveyor sub-assembly 142 may include a motor (not shown for simplicity) that may rotate arm 142(4).

Conveyor sub-assembly 142 may include a sensor 142(5). Sensor 142(5) may determine that a distance between arm 142(4) and picked items in container 90 is below a predefined threshold. Based on readings from sensor 142(5), controller 162 may control lifting mechanism 142(3) to elevate conveyor belt holder 142(1) in vertical direction 101 when the determined distance is below the predefined threshold. Controller 162 may control lifting mechanism 142(3) to elevate conveyor belt holder 142(1) in vertical direction 101 until the distance exceeds the predefined threshold.

For example, sensor 142(5) may include a brush 145(5a) coupled to arm 142(4) and a microswitch 142(5b). Microswitch 145(5b) may determine that brush 145(5a) contacts the picked items within container 90. Upon determination of the contact between brush 145(5a) and the items within container 90, microswitch 145(5b) may transmit a signal to controller 162. Based on the signal, controller 162 may control lifting mechanism 142(3) to elevate conveyor belt holder 142(1) in vertical direction 101. For example, controller 162 may control lifting mechanism 142(3) to elevate conveyor belt holder 142(1) until no contact between brush 145(5a) and the items in container 90 is determined.

Conveyor sub-assembly 142 may include a sensor (such as proximity sensors, for example magnetic proximity sensors or any other suitable proximity sensors; not shown for simplicity) that may generate a signal indicative of a position of conveyor belt holder 142(1) relative to frame 110. The signal may be transmitted for example to controller 162. For example, if the signal indicates that conveyor belt holder 142(1) has reached its most elevated position, it may indicate that container 90 is full with picked items. Based on the signal controller 162 may transmit a notification to the user to replace container 90.

Conveyor sub-assembly 142 may accurately and evenly (or substantially evenly) arrange the picked items within container 90. Accurate and even (or substantially even) arrangement of the picked items in container 90 may prevent mechanical damage of the picked items during harvesting.

Transverse conveyor sub-assembly 144 may include a conveyor belt holder 144(1) supporting a conveyor belt 144(2). Conveyor belt 144(2) may be formed of, for example, rubber material. Conveyor belt holder 144(1) may be coupled to frame 110 and/or to conveyor belt holder 142(1) of vertical conveyor sub-assembly 142. Conveyor belt holder 144(1) may extend in a direction that is transverse to vertical direction 101. Conveyor belt holder 144(1) may rotate with respect to frame 110 and/or conveyor belt holder 142(1) about an axis that is parallel to vertical direction 101 and/or about axis that is parallel to transverse direction 103. Conveyor belt 144(2) of transverse conveyor sub-assembly 144 may receive picked items and deliver the picked items to conveyor 142(2) of vertical conveyor sub-assembly 142. Conveyor belt 144(2) may include a plurality of items retaining members 144(2a) projecting from conveyor belt 144(2). Retaining members 144(2a) may retain picked items such as fruits, vegetables and/or any other suitable crop.

Retaining members 142(2a) and/or retaining members 144(2a) may include sponge elements 143. Sponge elements 143 may prevent retaining members 144(2a), 144(2a) from damaging picked items. Sponge elements 143 may be replaceable. The dimensions of sponge elements 143 may be selected, for example, based on the average size of the picked items to ensure the picked items fit in between the retaining members.

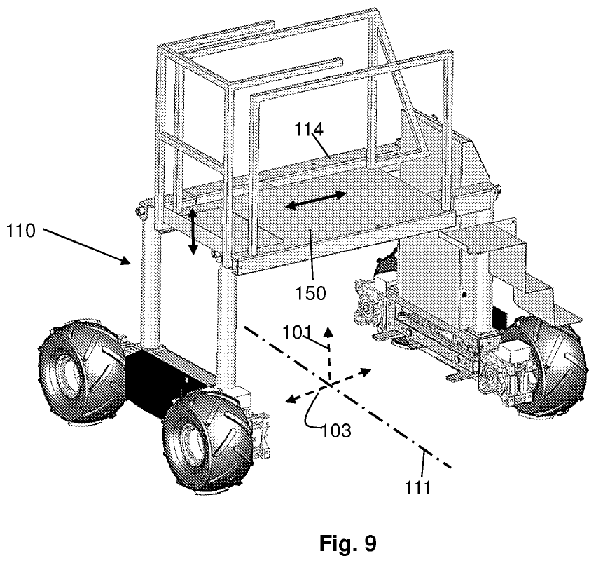

Reference is made to FIG. 9, which is a schematic illustration of frame 110 and platform 150, according to some embodiments of the invention. FIG. 9 shows a perspective view of frame 110 and platform 150.

Platform 150 may be coupled to frame 110. For example, platform 150 may be coupled to third frame portion 114. Platform 150 may be retractably extendable in transverse direction 103 and/or in vertical direction 101. Machine 100 may include stairs 152 coupled to frame 110.

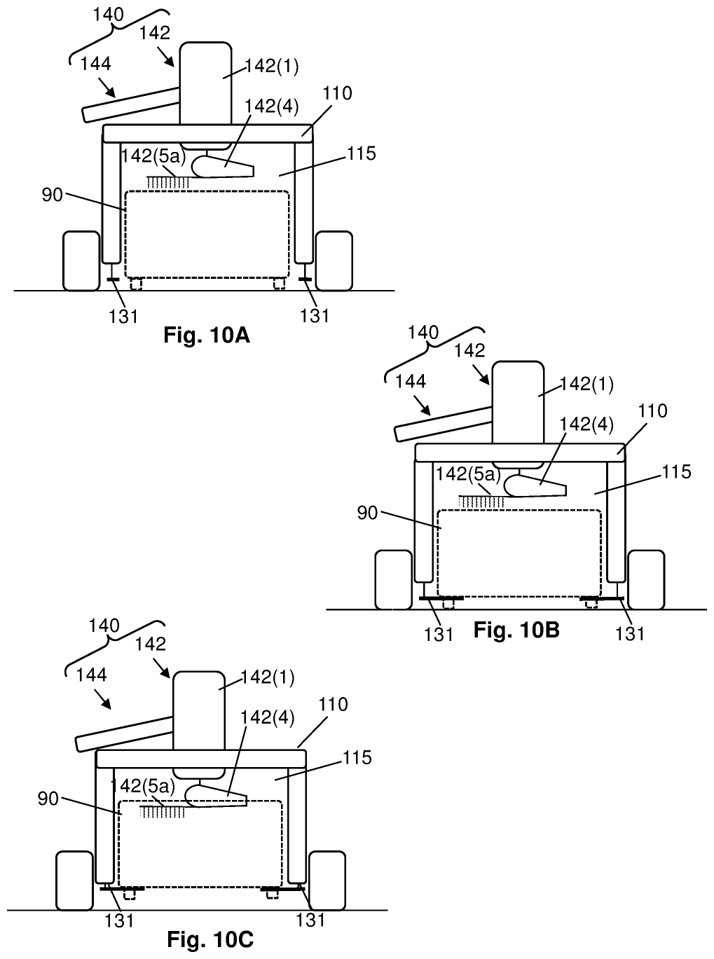

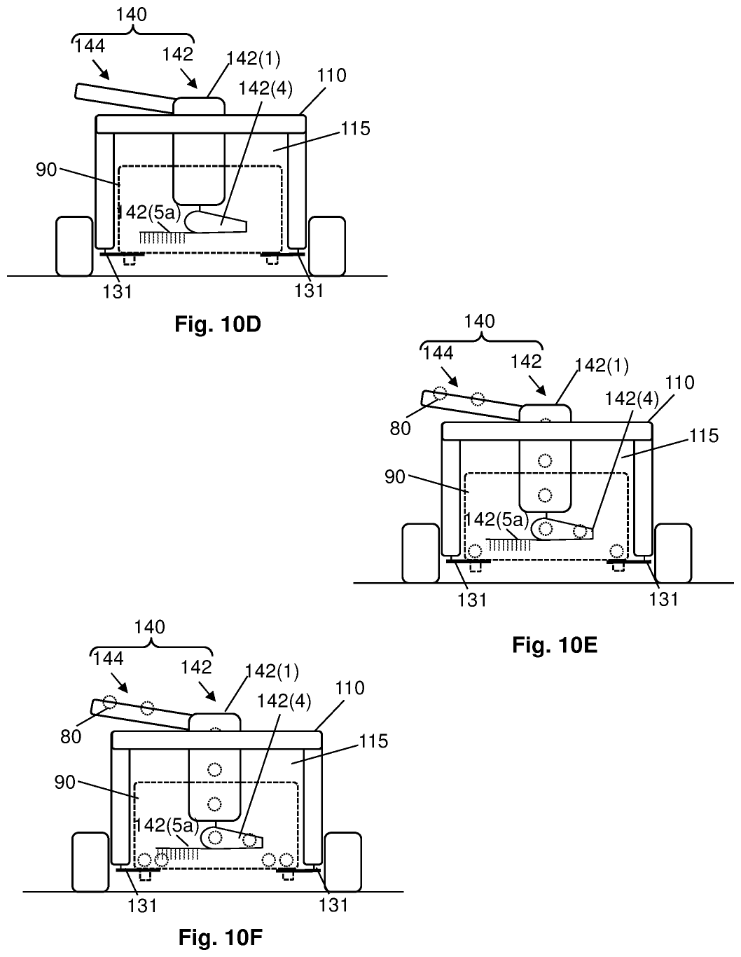

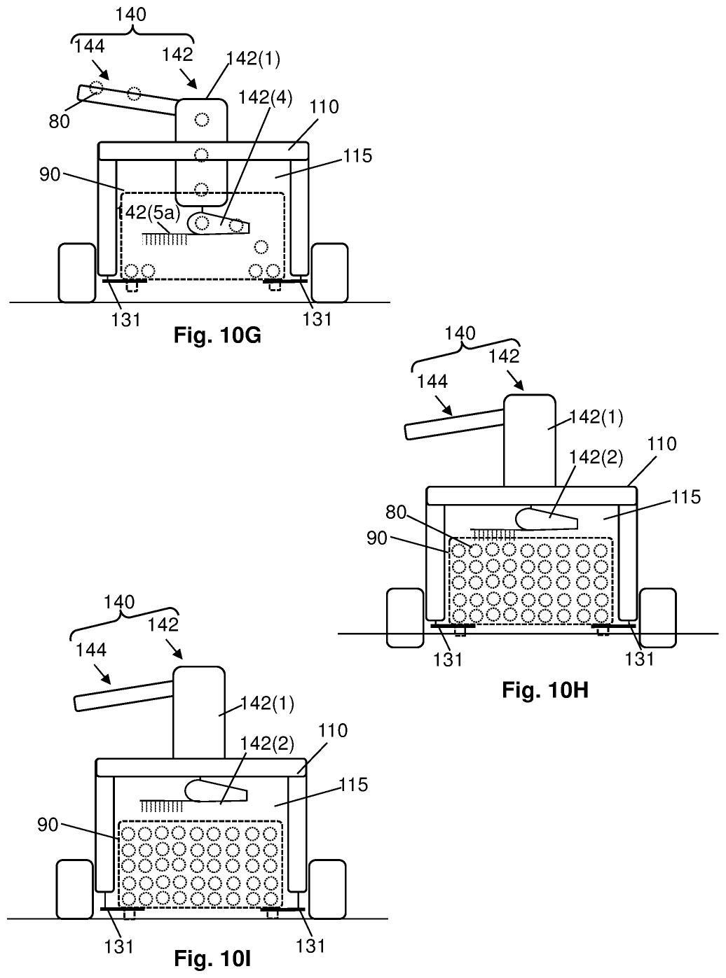

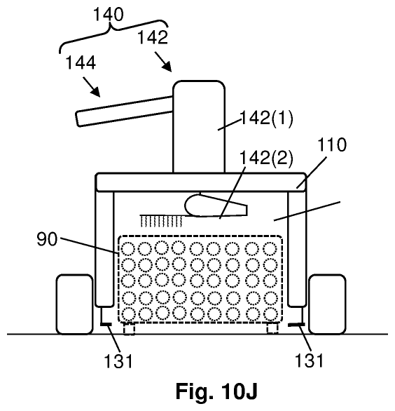

Reference is made to FIGS. 10A-10J, which are schematic illustrations of machine 100 in operation, according to some embodiments of the invention.

Machine 100 may operate in the field, for example between tree or other plant lines. Machine 100 may be operated by a user. For example, the user may send command signals to controller 162 of machine 100 using a remote computing device. Based on the command signals, controller 162 of machine 100 may control components of machine 100 to perform operations such as operations described below with respect to FIGS. 10A-10J, for example as described hereinabove.

In operation shown in FIG. 10A, machine 100 may move towards an empty container 90. When container 90 is disposed in container space 115 created by frame 110, machine 100 may stop. To allow machine 100 to pass over container 90, the container engaging structural elements such as prongs 131 (as shown in FIGS. 10A-10J) or container holders 134 (described above with respect to FIGS. 7A-7C. 7D) of container holding and lifting assembly 130 may be retracted from container space 115 (e.g., as described above with respect to FIGS. 4A-4B, FIGS. 5A-5C and FIG. 6).

In operation shown in FIG. 10B, the container engaging structural elements such as prongs 131 (as shown in FIGS. 10A-10J) or container holders 134 (described above with respect to FIGS. 7A-7D) may be extended into container space 115 to engage with container 90 (e.g., as described above with respect to FIGS. 4A-4B, FIGS. 5A-5C, FIG. 6 and FIGS. 7A-7D).

In operation shown in FIG. 10C, the container engaging structural elements such as prongs 131 (as shown in FIGS. 10A-10J) or container holders 134 (described above with respect to FIGS. 7A-7C. 7D) may be elevated in vertical direction 101 to elevate container 90 from the ground (e.g., as described above with respect to FIGS. 5A-5C).

In operation shown in FIG. 10D, conveyor belt holder 142(1) of vertical conveyor sub-assembly 142 of items arranging assembly 140 may be lowered into container space 115 to position arm 142(4) within container 90, for example close to the bottom of container 90 (e.g., as described above with respect to FIGS. 8A-8B).

In operation shown in FIG. 10E, conveyors (not shown in FIGS. 10A-10J for simplicity) of vertical conveyor sub-assembly 142 and of transverse conveyor sub-assembly 144 may convey items 80 picked by the user and deliver items 80 into container 90 (e.g., as described above with respect to FIGS. 8A-8B). Arm 142(4) of vertical conveyor sub-assembly 142 may continuously rotate about rotation axis 142(4b) to evenly (or substantially evenly) arrange items 80 within container 90 (e.g., as described above with respect to FIGS. 8A-8B).

In operation shown in FIG. 10F, brush 142(5a) may contact items 80 in container 90.

In operation shown in FIG. 10G, container belt holder 142(1) of vertical conveyor sub-assembly 142 may be elevated in vertical direction 101 until no contact between brush 145(5a) and items 80 in container 90 is determined (e.g., as described above with respect to FIGS. 8A-8B).

Operations shown in FIGS. 10F-10G may be repeated until container belt holder 142(1) of vertical conveyor sub-assembly 142 reaches its most elevated position as shown in FIG. 10H (e.g., as described above with respect to FIGS. 8A-8B).

In operation shown in FIG. 10I, the container engaging structural elements such as prongs 131 (as shown in FIGS. 10A-10J) or container holders 134 (described above with respect to FIGS. 7A-7C, 7D) may be lowered to lower container 90 and position container on the ground (e.g., as described above with respect to FIGS. 5A-5C).

In operation shown in FIG. 10J, the container engaging structural elements such as prongs 131 (as shown in FIGS. 10A-10J) or container holders 134 (described above with respect to FIGS. 7A-7C, 7D) may be retracted from within container space 115 (e.g., as described above with respect to FIGS. 4A-4B, FIGS. 5A-5C. FIG. 6 and FIGS. 7A-7D) and machine 100 may pass above container 90, for example towards next container 90 in the field.

Frame 110 of machine 100 may allow machine 100 to pass above full containers 90 or other obstacles in the field without significantly maneuvering machine 100. This may be advantageous when operating between dense tree or other plant lines. This may also eliminate a need in immediate removal of full containers 90 from the field.

Compact and maneuverable design of machine 100 may allow deploying a plurality of machines 100 in the field. Preferably, single machine 100 should be used by a single user. Having a plurality of users each using separate machine 100 may increase the harvesting rate of the entire group since the harvesting rate without limiting the harvesting rate of the group to the harvesting rate of the slowest user in the group. For example, if each of the users in the group is using separate machine 100, the average harvesting rate of the group may be expressed by an equation below:

(Average harvesting rate of the group)==[(Harvesting rate of 15user)+ . . . +(Harvesting rate of N^{th} user)]/(Number of users)

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items.

The invention is not limited to those diagrams or to the corresponding descriptions. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

Unless specifically stated otherwise, as apparent from the above discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

1. A harvesting assisting machine comprising:
a frame having a longitudinal frame axis, the frame comprising:
a first side frame portion and a second side frame portion extending in a vertical direction that is perpendicular to the longitudinal frame axis, the first side frame portion and second side frame portion being disposed on opposing sides of the longitudinal frame axis,
a third frame portion interconnecting the first side frame portion and the second side frame portion,
wherein the first side frame portion, the second side frame portion and the third frame portion create a container space extending along the entire length of the longitudinal frame axis, the container space being configured to accommodate a container;
a plurality of wheels coupled to bottom portions of the first side frame portion and second side frame portion; and
a container holding and lifting assembly coupled to the frame, the container holding and lifting assembly being configured to releasably hold the container within the container space and to elevate and lower the container in the vertical direction.

2. The machine of claim 1, wherein the container holding and lifting assembly comprises a plurality of structural elements retractably extendable into the container space, the structural elements being configured to engage with the container when extended into the container space.

3. The machine of claim 1, wherein the container holding and lifting assembly comprises a plurality of prongs coupled to bottom portions of the first side frame portion and second side frame portion, the prongs being retractably extendable into the container space and being configured to engage with a bottom surface of the container.

4. The machine of claim 3, wherein the prongs are rotatable about respective rotation axes to extend into the container space and retract from the container space, the rotation axes being parallel to the vertical direction.

5. The machine of claim 3, wherein the prongs are slidable into the container space and from the container space to extend into the container space and retract from the container space, respectively.

6. The machine of claim 1, wherein the container holding and lifting assembly comprises a plurality container holders coupled to bottom portions of the first side frame portion and the second side frame portion, the container holders being retractably extendable into the container space and being configured to engage with side surfaces of the container.

7. The machine of claim 3, wherein the container holding and lifting assembly comprises:
two pairs of sub-assemblies, each of the pairs being coupled to a bottom portion of one of the first side frame portion and the second side frame portion and comprising:
a lifting sub-assembly coupled to the bottom portion of the respective side frame portion; and
a prongs actuating sub-assembly coupled to the lifting sub-assembly.

8. The machine of claim 7, wherein the prongs actuating sub-assembly comprises:
a prongs supporting structure extending in a direction that is parallel to the longitudinal frame axis; and
a first prong and a second prong of the plurality of prongs coupled to the prongs supporting structure at opposing ends of the prongs supporting structure, the first prong and the second prong being rotatable with respect to the prongs supporting structure about rotation axes extending in the vertical direction;
an actuator coupled to the prongs supporting structure; and
a rod coupled to the actuator, the first prong and the second prong, the rod extending in the direction that is parallel to the longitudinal frame axis;
wherein the actuator and the rod are configured to cause the first prong and the second prong to rotate with respect to the prongs supporting structure.

9. The machine of claim 8, wherein the direction of rotation of the first prong and the second prong with respect to the prongs supporting structure upon actuation is dictated by positions of coupling points of the rod to the first prong and the second prong relative to an axis extending through the first prong and the second prong and being parallel to the longitudinal frame axis.

10. The machine of claim 7, wherein the lifting sub-assembly comprises:
a sub-frame coupled to the to the bottom portion of the respective side frame portion, the sub-frame extending in a direction that is parallel to the longitudinal frame axis;
a first crankshaft and a second crankshaft coupled to the sub-frame along an axis that is parallel to the longitudinal frame axis, the first crankshaft and the second crankshaft being rotatable with respect to the sub-frame about respective rotation axes that are perpendicular to the longitudinal frame axis, the first crankshaft and the second crankshaft being coupled to the prongs actuating sub-assembly;
a motor coupled to the sub-frame; and
a transmission coupling the motor to the first crankshaft and the second crankshaft;
wherein the motor and the transmission are configured to cause the first crankshaft and the second crankshaft to rotate to elevate and lower the prongs actuating sub-assembly coupled thereto.

11. The machine of claim 1, comprising an items arranging assembly coupled to the frame, the items arranging assembly being configured to receive items and arrange the items in the container.

12. The machine of claim 11, wherein the items arranging assembly comprises a vertical conveyor sub-assembly, the vertical conveyor sub-assembly comprising:
a conveyor belt holder extending in the vertical direction and supporting a conveyor belt;
an arm coupled to a bottom portion of the conveyor belt holder and comprising a concave surface configured to receive the items from the conveyor belt and deliver the items into the container, the arm being rotatable about a rotation axis that extends in the vertical direction; and
a lifting mechanism configured to lower the conveyor belt holder into the container space and elevate the conveyor belt holder from within the container space in the vertical direction.

13. The machine of claim 12, wherein the conveyor belt comprises a plurality of item retaining members configured to retain items.

14. The machine of claim 12, wherein the items arranging assembly comprises a sensor configured to determine that a distance between the arm and the items in the container is below a threshold.

15. (canceled)

16. The machine of claim 14, wherein the sensor comprises a brush coupled to the arm and a microswitch configured to sense a contact of the brush with the items in the container.

17. The machine of claim 11, wherein the items arranging assembly comprises a transverse conveyor sub-assembly, the transverse conveyor sub-assembly comprising a conveyor belt holder and supporting a conveyor belt, the conveyor belt holder extending substantially in a direction that is transverse to the vertical direction.

18. The machine of claim 11, wherein the conveyor belt of the transverse conveyor sub-assembly comprises a plurality of item retaining members configured to retain items.

19. The machine of claim 1, wherein the third frame portion is a retractable and extendable in a direction that is perpendicular to the longitudinal frame axis and the vertical direction to change a distance between the first side frame portion and the second side frame portion.

20. The machine of claim 1, comprising a platform on which a user may stand, the platform being coupled to the frame, wherein the platform is retractable and extendable in the vertical direction, in a direction that is transverse to the vertical direction, or in both directions.

21. (canceled)

22. The machine of claim 1, comprising a plurality of motors, each of the motors being configured to power one of the wheels.

23. (canceled)

24. (canceled)
